(19) United States
(12) Patent Application Publication
(10) Pub. No.: US 2026/0138480 A1
(43) Pub. Date: May 21, 2026

(54) POWER CONTROL SYSTEM WITH A POWER SPLITTER

(71) Applicant: GM Global Technology Operations LLC, Detroit, MI (US)

(72) Inventors: Minh-Khai Nguyen, Troy, MI (US); Lei Hao, Troy, MI (US); Samantha Gunter Miller, Berkley, MI (US); Firas Shabo, Shelby Twp, MI (US)

(73) Assignee: GM Global Technology Operations LLC, Detroit, MI (US)

(21) Appl. No.: 18/955,902

(22) Filed: Nov. 21, 2024

(51) Int. Cl. B60L 53/60; B60L 1/00; B60L 50/60; H02J 7/02

(52) U.S. Cl. CPC B60L 53/60; B60L 1/006; B60L 50/60; H02J 7/02; B60L 2210/20; H02J 2207/20

(57) ABSTRACT

Provided is a power control system, for providing power to an outlet and a battery from a first power source. The first power source transmits electric power at a predetermined voltage and phase to an onboard charger module which regulates the power to charge a battery. The power control system includes a splitter module interposed between the first power source and the onboard charger module, the splitter operable to provide transmit electric power in one of a plurality of phases.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a power distribution system for charging a battery and providing power to an outlet. For instance, an electric vehicle includes a battery for powering a motor to drive the vehicle and vehicle electric components such as a head unit, lights, air conditioning and the like. Some electric vehicles include one or more outlets that users may use to power personal electric devices such as cellular phones and tablets.

The electric vehicle further includes an inlet for accepting power from a charger coupled to a power utility station to charge the battery. The inlet may be configured to accept alternating current (“AC”) at 120 volts or at 240 volts and the voltage may be delivered in different phases. The charging power is regulated and controlled by an on-board charger module (“OBCM”). Currently, the OBCM shuts off power to the outlets in the electric vehicle when the battery is being charged to facilitate the regulation and control of power to the battery when the charger is plugged into the inlet.

Some electric devices that may be plugged into the vehicle outlet are configured to receive 120 volts of AC power while others may be configured to receive 240 volts of power. Some electric devices may be configured to receive power at a single phase while others are configured to receive power at three phases. Thus, plugging an electric device configured to receive 120 volts of power into an outlet of a vehicle that is being charged by a 240-volt source may damage the electric device. On the other hand, plugging an electric device configured to receive 240 volts of power into an outlet of a vehicle that is being charged by a 120-volt source may not power the electric device. Further, such electric devices may be configured to operate using power having different waveforms.

Accordingly, it is desirable to have a power distribution system wherein the outlets may be operable to distribute power when the battery is being charged. It is further desirable to adjust the waveform of the power to accommodate a predetermined electric device.

### SUMMARY

One aspect of the disclosure provides a power control system for providing power from a first power source to an outlet and a battery, wherein the battery is configured to power a motor. The first power source transmits electric power in the form of an alternating current. The power control system includes an onboard charger module having a first processing unit configured to process the electric power from the first power source to charge the battery. The first processing unit includes a non-volatile memory that stores written instructions for the execution of the onboard charger module. The power control system further includes a splitter module interposed between the first power source and the onboard charger module, wherein the splitter module is operable to provide electric power in one of a plurality of phases.

Implementations of the disclosure may include one or more of the following optional features. In some implementations, the plurality of phases includes a single phase and a three phase.

In some examples, the splitter module includes a first switch unit and a second switch unit.

In some examples, the power control system further includes a first input line, a second input line, a third input line, and a fourth input line that is a neutral line. The first input line, the second input line, the third input line, and the fourth input line connect the first power source to the battery through an AC to DC converter. The power control system may further include a first output line, a second output line, a third output line, and a fourth output line. The fourth output line is a neutral line. In such an aspect, one end of the first output line, the second output line, the third output line, and the fourth output line is connected to a corresponding one of the first input line, the second input line, the third input line, and the fourth input line and the other end of the first output line, the second output line, the third output line, and the fourth output line is connected to the outlet.

In some examples, the first switch unit is configured to selectively open and close each one of the first input line, the second input line, the third input line, and the fourth input line, and the second switch unit is configured to selectively open and close each one of the first output line, the second output line, the third output line, and the fourth output line.

In some examples, the power control system further includes an alternating current-alternating current converter (AC-AC converter). In such an aspect, the second switch unit may be disposed within the AC-AC converter. In another aspect, AC-AC converter is one of a buck converter, buck-boost converter, and single-ended-primary-inductor converter with non-isolation or isolation.

Another aspect of the disclosure provides an electric vehicle including a battery, an inlet and an outlet. The battery is configured to power a drive force of the electric vehicle. The inlet is configured to receive electric power from a first power source and the outlet is configured to power a load. The electric vehicle includes a first input line, a second input line, a third input line, and a fourth input line. The fourth input line is a neutral line, and the first input line, the second input line, the third input line, and the fourth input line electrically connect the inlet to the battery through an AC to DC converter. The electric vehicle includes a first output line, a second output line, a third output line, and a fourth output line. The fourth output line is a neutral line and one end of the first output line, the second output line, the third output line, and the fourth output line is connected to a corresponding one of the first input line, the second input line, the third input line, and the fourth input line and the other end of the first output line, the second output line, the third output line, and the fourth output line is connected to the outlet. The electric vehicle further includes an onboard charger module and a splitter module. The onboard charger module includes a first processing unit configured to process the electric power from the first power source to charge the battery. The first processing unit includes a non-volatile memory that stores written instructions for the execution of the onboard charger module. The splitter module is interposed between the first power source and the onboard charger module and is operable to transmit the electric power in one of a plurality of phases.

In some implementations, the splitter module includes a first switch unit and a second switch unit. In such an implementation, the first switch unit is configured to selectively open and close each one of the first input line, the second input line, the third input line, and the fourth input line and the second switch unit is configured to selectively open and close each one of the first output line, the second output line, the third output line, and the fourth output line.

In some implementations, the splitter module includes a sensing unit configured to measure a value of at least one of a current and a voltage.

In some implementations, the splitter module includes a second processing unit configured to receive the measured value of at least one of the current and the voltage to actuate the first switch unit and the second switch unit. In such an implementation, the first processing unit of the onboard charger module transmits a charging information of the battery to the second processing unit of the splitter module, wherein the second processing unit processes the charging information to control the first switch unit and the second switch unit so as to transmit electric power in a selected one of the plurality of phases to the outlet and the battery.

In some implementations, the electric vehicle further includes an alternating current-alternating current converter (AC-AC converter). In such an implementation, the second switch unit may be disposed within the AC-AC converter.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle showing a power control system of the vehicle coupled to a first power source;

FIG. 2 is a schematic view of the power control system shown in FIG. 1;

FIG. 3 is a schematic view of the power control system shown in FIG. 1 providing a single phase of power to the outlet from a three-phase source;

FIG. 4 is a schematic view of the power control system shown in FIG. 1 providing a single-phase voltage to the outlet from a single-phase voltage source;

FIG. 5 is a schematic view of the power control system shown in FIG. 1 providing a three-phase voltage to the outlet from a single-phase voltage source;

FIG. 6 is a schematic view of the power control system shown in FIG. 1 operating off-grid and providing a single-phase voltage to the outlet from the battery; and

FIG. 7 is a schematic view of the power control system shown in FIG. 1 operating off-grid and providing a three-phase voltage to the outlet from the battery.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The present disclosure relates to a power control system 10 for providing power to an outlet 12 and a battery 14 from a first power source 16. The outlet 12 is configured to be detachably coupled to an electric load and the battery 14 may be configured to provide power to a fixed load. The first power source 16 transmits electric power in the form of an alternating current at a predetermined voltage to a power inlet 18 that is electrically coupled to an onboard charger module 20 which regulates the power to charge the battery 14. The first power source 16 may be configured to provide industry standard charging. For instance, the first power source 16 may be a commercially developed charging station configured to provide electrical power at 120 volts or 240 volts or may be a residential outlet configured to provide power at 120 volts or 240 volts.

The onboard charger module 20 includes a first processing unit 22 that is configured to process the electric power from the first power source 16 to charge the battery 14. The first processing unit 22 includes a non-volatile memory 22a that stores written instructions for the execution of the onboard charger module 20. The power control system 10 further includes a splitter module 24 that is interposed between the power inlet 14 and the onboard charger module 20. The splitter module 24 is configured to direct electric power from the first power source 16 to the outlet 12. For instance, the splitter module 24 may be configured to supply power to an outlet 12 disposed in a vehicle 26 to which the load (not shown) may be coupled. The outlet 12 may be a standard three prong outlet 12 for United States purposes or a two-prong outlet for European purposes. It should be appreciated that the outlet 12 may be configured to accommodate any industry standard without deviating from the scope of the appended claims.

Not all power sources provide the same electric power. For instance, some power sources may provide 110 volts, while others provide 120 volts or 220 volts or 240 volts. In addition to the voltage, some power sources provide single-phase power while others provide three-phase power. Likewise, electric devices may have different power configurations with some electric devices configured to receive 120 volts of power at a single phase while others may require 220 volts at three phases. The splitter module 24 is configured to transmit electric power to the outlet 12 at a desired phase and may be further configured to step up or step down the voltage, thereby providing power to the outlet 12 at a predetermined phase and voltage to accommodate the power configuration of the electric device.

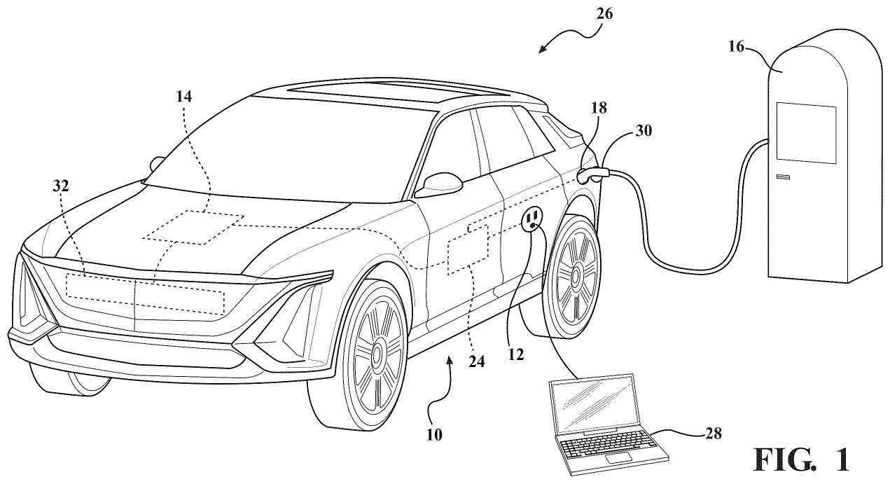

The power control system 10 may be implemented in any platform or device that utilizes a battery 14 to power the device. For illustrative purposes, the power control system 10 is described in the context of an electric vehicle 26, as shown in FIG. 1. However, it should be appreciated that the power control system 10 may be implemented in other devices/platforms, such as a boat, a motorcycle, a residential or commercial building and the like, having a battery 14 for powering the device/platform and an outlet 12 for powering an electric device 28 such as a laptop, an electric vehicle, a mobile device or the like.

FIG. 1 depicts the vehicle 26 coupled to the first power source 16. In particular, the first power source 16 includes a charger 30 that is coupled to the power inlet 18 to provide power to charge the battery 14. The first power source 16 is illustratively shown as a commercial charging station, but it should be appreciated that the first power source 16 may be a residential outlet as well. It should be appreciated that the first power source 16 may be any power source configured to connect with the power inlet 18 and the examples described herein are not limiting.

The vehicle 26 is an electric vehicle 26 having a battery 14 configured to power a motor 32 for driving the vehicle 26. For instance, the motor 32 may be an electric motor 32 configured to generate as much as 200 horsepower to drive the vehicle 26. Any battery 14 configured to be charged with electrical power currently known or later developed may be modified for use herein, illustratively including lithium-ion batteries, solid state batteries, and the like. The capacity of the battery 14 need not be limiting and may include batteries 14 having a capacity greater than 30 kilowatts-hour (kWh). The battery 14 is further configured to power the various electronic components within the vehicle 26. Such electronic components are well known and illustratively include lights, windshield wipers, a head unit, heating and air conditioning and the like.

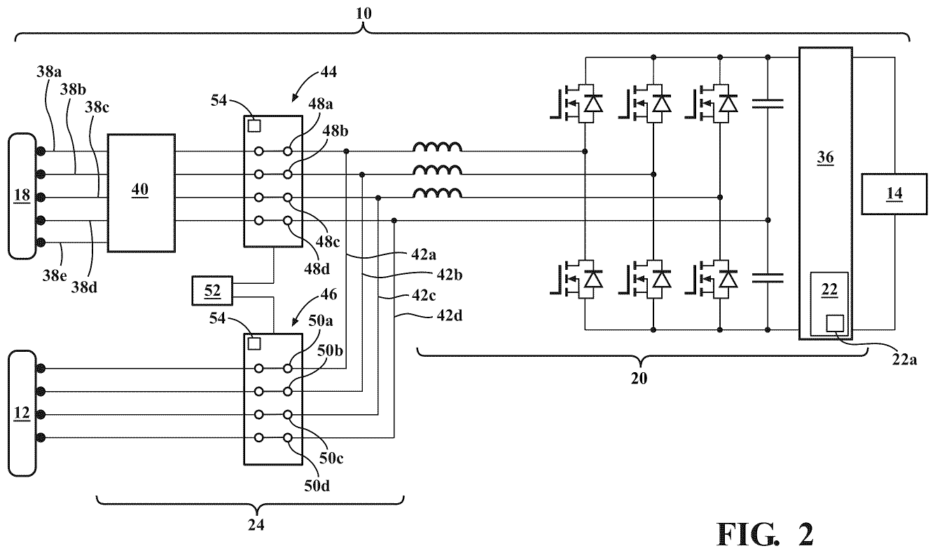

With reference now to FIG. 2, the power control system 10 includes an onboard charger module 20 and a splitter module 24. In some configurations, the onboard charger module 20 and the splitter module 24 are integrated as a single module. In other configurations, the onboard charger module 20 and the splitter module 24 are separate units. The onboard charger module 20 is configured to regulate power from the first power source 16 via the power inlet 18 to charge the battery 14. For instance, the onboard charger module 20 may include electronic circuits and components configured to filter noise, maintain the power supplied to the battery 14 at a predetermined voltage, maintain a predetermined waveform and perform other processes to provide the battery 14 with power that is optimal for charging operations. For example, the onboard charger module 20 may include a power factor correction circuit configured to regulate power to/from the power source 16 and to the power outlet(s) 12 within the vehicle 26.

The onboard charger module 20 includes power electronic switches, such as power MOSFET switches, which may be turned on and off to regulate a duty cycle of the electric power, step up or step down the voltage, and change the waveform of the electric power supplied to the battery 14. The onboard charger module 20 may be further configured to provide a galvanic isolation between the electric device 28 and the battery 14. For instance, the onboard charger module 20 may further include an isolated DC-DC converter 36, which may include a transformer (not shown). The operation of the transformer provides a galvanic isolation between the electric device 28 and the battery 14.

The onboard charger module 20 may include a first processing unit 22 that is configured to actuate the electronic components, such as the MOSFET switches, to process the electric power from the first power source 16 to charge the battery 14. The first processing unit 22 includes a non-volatile memory 22a for storing written instructions for the execution of the electronic components, the instructions may be updated as needed.

With continued reference to FIG. 2, the power control system 10 includes a splitter module 24 that is interposed between the power inlet 18 and the onboard charger module 20. As described above, the power inlet 18 is configured to receive electric power from the first power source 16. In one aspect, the power inlet 18 includes a first input line 38a, a second input line 38b, a third input line 38c, and a fourth input line 38d. The first input line 38a, the second input line 38b, and the third input line 38c are configured to provide electric power having different phases and the fourth input line 38d is a neutral line that provides a return to the first power source 16 to generate a voltage differential between the corresponding first input line 38a, the second input line 38b, and the third input line 38c. In some implementations, a fifth input line 38e is provided that provides a line to ground. A filter 40 may be couped to the first input line 38a, the second input line 38b, the third input line 38c, and the fourth input line 38d to remove noise received by the power inlet 18 from the first power source 16.

The power control system 10 further includes a first output line 42a, a second output line 42b, a third output line 42c, and a fourth output line 42d. One end of the first output line 42a, the second output line 42b, the third output line 42c, and the fourth output line 42d is coupled to a corresponding first input line 38a, second input line 38b, third input line 38c, and fourth output line 38d. The other end of the first output line 42a, the second output line 42b, the third output line 42c, and the fourth output line 42d is coupled to the outlet 12. The first input line 38a, second input line 38b, third input line 38c, fourth input line 38d, first output line 42a, second output line 42b, third output line 42c, and fourth output line 42d may be formed of an electrically conductive wire or a cable formed of a plurality of electrically conductive wires. For illustrative purposes, the vehicle 26 is shown as having a single outlet 12, but it should be appreciated that the vehicle 26 may have more than one outlet 12. In some aspects, the power control system 10 may further include a fifth output line 42e configured to ground electric power.

The splitter module 24 includes a first switch unit 44 and a second switch unit 46. The first switch unit 44 is operatively coupled to the first input line 38a, the second input line 38b, the third input line 38c, and the fourth input line 38d. The second switch unit 46 is operatively coupled to the first output line 42a, the second output line 42b, the third output line 42c, and the fourth output line 42d. The first switch unit 44 and the second switch unit 46 are configured to selectively open and close the first input line 38a, the second input line 38b, the third input line 38c, the fourth input line 38d, the first output line 42a, the second output line 42b, the third output line 42c, and the fourth output line 42d to provide for the transmission of electric power to the onboard charger module 20 and the outlet 12 as the case may be.

In one aspect, the first switch unit 44 includes a first input switch 48a, a second input switch 48b, a third input switch 48c, and a fourth input switch 48d each disposed on a corresponding first input line 38a, second input line 38b, third input line 38c, and fourth input line 38d. Likewise, the second switch unit 46 includes a first output switch 50a, a second output switch 50b, a third output switch 50c, and a fourth output switch 50d each disposed on a corresponding first output line 42a, second output line 42b, third output line 42c, and fourth output line 42d. The switches may be a bidirectional switch built by two MOSFET switches or two transistors with back-to-back connection, a relay switch or the like. In one aspect, the power control system 10 may include a fifth output switch 50e configured to open and close the fifth output line 42e to selectively ground the power.

The first switch unit 44 and the second switch unit 46 may be controlled by the first processing unit 22 of the onboard charger module 20. In another aspect, the splitter module 24 includes a second processing unit 52 configured to control the operation of the first switch unit 44 and the second switch unit 46. The splitter module 24 may include a sensor 54 configured to detect the electrical power in each of the first input line 38a, second input line 38b, third input line 38c, fourth input line 38d, first output line 42a, second output line 42b, third output line 42c and fourth output line 42d. The sensor 54 may be configured to detect multiple characteristics of the electrical power to include current, voltage and phase. Information from the sensor 54 may be processed by the onboard charger module 20 or the second processing unit 52 to control the operation of the first switch unit 44 and the second switch unit 46. Accordingly, the power control system 10 is configured to detect the electrical power received by the power inlet 18 and deliver the electrical power to the outlet 12 in a desired voltage and phase.

FIG. 2 depicts an instance where the electric power from the first power source 16 and received by the power inlet 18 is 220 volts and in three phases and the desired output to the outlet 12 is 220 volts at three phases. In such an instance, the sensor 54 detects that the first input line 38a, the second input line 38b, and the third input line 38c are transmitting 220 volts at different phases. The first processing unit 22 or the second processing unit 52, as the case may be, processes the information from the sensor 54 and closes the first input switch 48a, the second input switch 48b, the third input switch 48c, the fourth input switch 48d, the first output switch 50a, the second output switch 50b, the third output switch 50c, and the fourth output switch 50d. Under such a configuration, the onboard charger module processes 220 volts at three phases to charge the battery 14 and deliver 220 volts at three phases to the outlet 12.

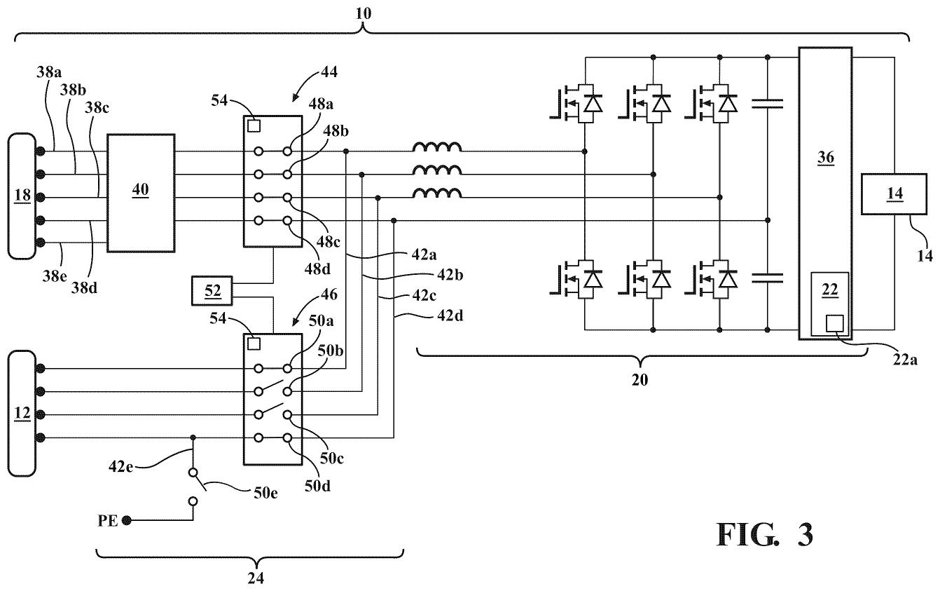

FIG. 3 depicts an instance where the electric power from the first power source 16 is provided at 220 volts and in three phases and the desired output to the outlet 12 is 220 volts at a single phase. In such an instance, the sensor 54 detects that the first input line 38a, the second input line 38b, and the third input line 38c are transmitting 220 volts at different phases. The first processing unit 22 or the second processing unit 52, as the case may be, processes the information from the sensor 54 and configures the first switch unit 44 and the second switch unit 46 to provide three phases of 220 voltage to charge the battery while providing 220 volts at a single phase to the outlet 12. For instance, the first input switch 48a, the second input switch 48b, the third input switch 48c, the fourth input switch 48d, the first output switch 50a, and the fourth output switch 50d may be closed and the second output switch 50b and the third output switch 50c are open.

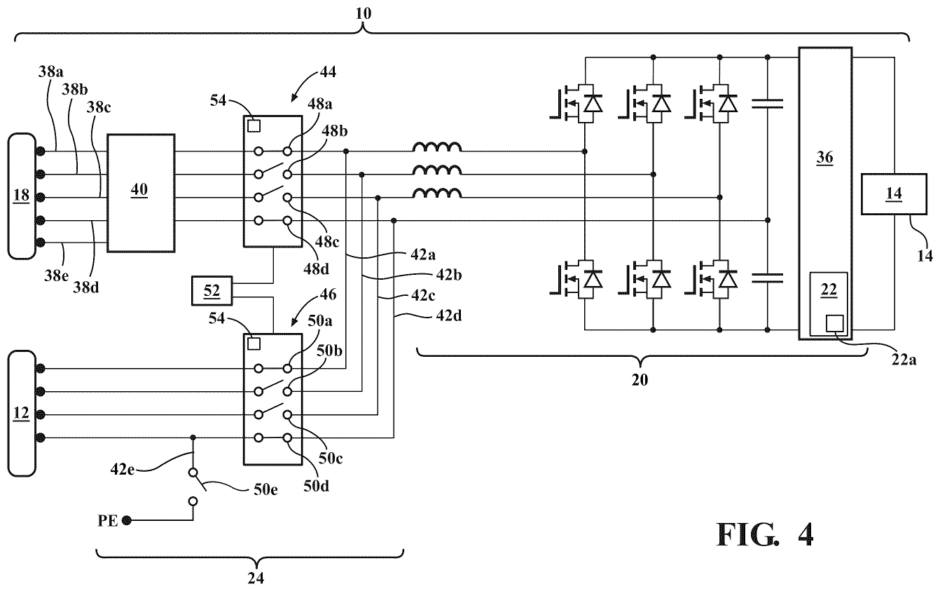

FIG. 4 depicts an instance where the electric power from the first power source 16 is provided at 110 volts and a single phase and the desired output to the outlet 12 is 110 volts at a single phase. In such an instance, the sensor 54 detects that the first input line 38a is transmitting 110 volts and that no electrical power is transmitted along the second input line 38b and the third input line 38c or that the power in the second input line 38b and the third input line 38c is the same phase as the power transmitted along the first input line 38a. The first processing unit 22 or the second processing unit 52 processes the information from the sensor 54 and configures the first switch unit 44 and the second switch unit 46 to provide a single phase of 110 voltage to charge the battery 14 and to the outlet 12. For instance, the first input switch 48a, the fourth input switch 48d, the first output switch 50a, and the fourth output switch 50d are closed and the second input switch 48b, the third input switch 48c, the second output switch 50b, and the third output switch 50c are open.

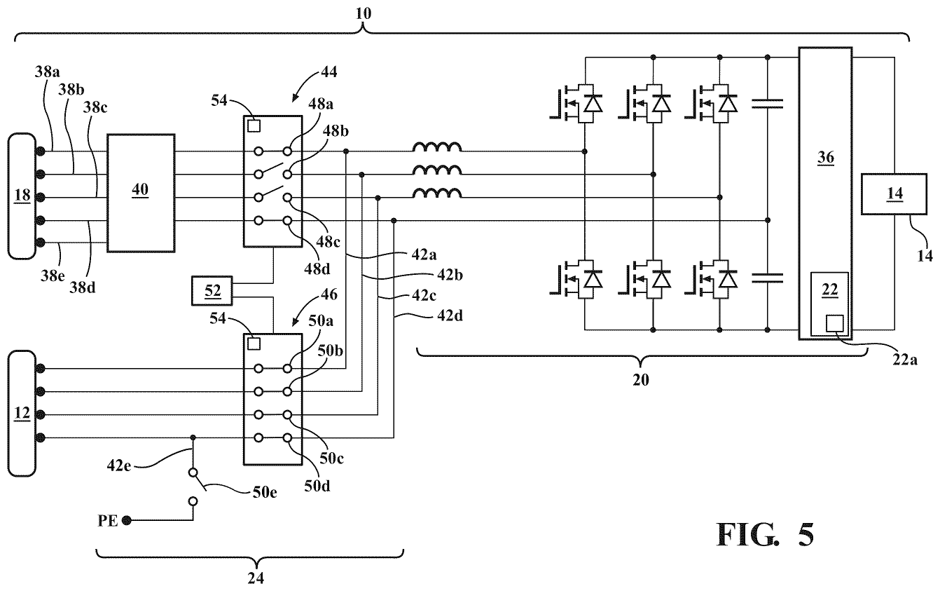

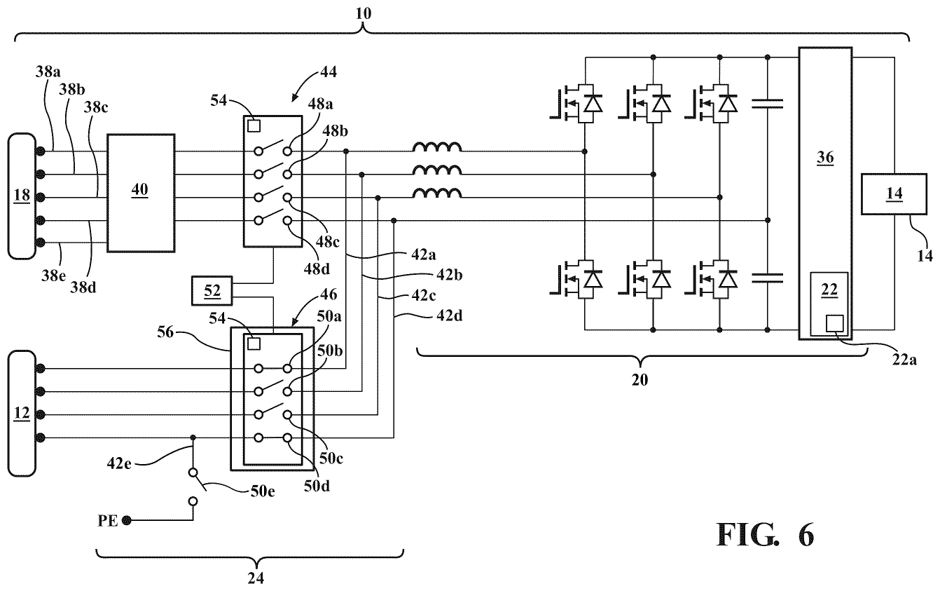

FIG. 5 depicts an aspect where the electric power from the first power source 16 is provided at 110 volts and a single phase and the desired output to the outlet 12 is 220 volts at three phases. In such an aspect, the outlet 12 may be configured to charge another electric vehicle. In such an instance, the sensor 54 detects that the first input line 38a is transmitting 110 volts and that no electrical power is transmitted along the second input line 38b and the third input line 38c. The first processing unit 22 or the second processing unit 52 processes the information from the sensor 54 and configures the first switch unit 44 and the second switch unit 46 to provide a single phase of 110 voltage to charge the battery and 120 volts at three phases to the outlet 12. For instance, the first input switch 48a, the fourth input switch 48d, the first output switch 50a, the second output switch 50b, the third output switch 50c, and the fourth output switch 50d are closed and the second input switch 48b and the third input switch 48c are open. In such an aspect, the second switch unit 46 may be further configured to step up power and modify the phases in each of the first output line 42a, second output line 42b and third output line 42c. For instance, as shown in FIG. 6, the second switch unit 46 may be disposed within an AC-AC converter 56. The AC-AC converter 56 may be configured to regulate the power from the first power source 16 and/or the battery 14. Any AC-AC converter 56 currently known or later developed may be modified for use herein, illustratively including a buck converter, buck-boost converter, single-ended-primary-inductor converter, a switch-capacitor AC-AC converter, and a back-to-back AC-AC converter. Further, it should be appreciated that the AC-AC converter 56 may be a non-isolated AC-AC converter or an isolated AC-AC converter with a transformer.

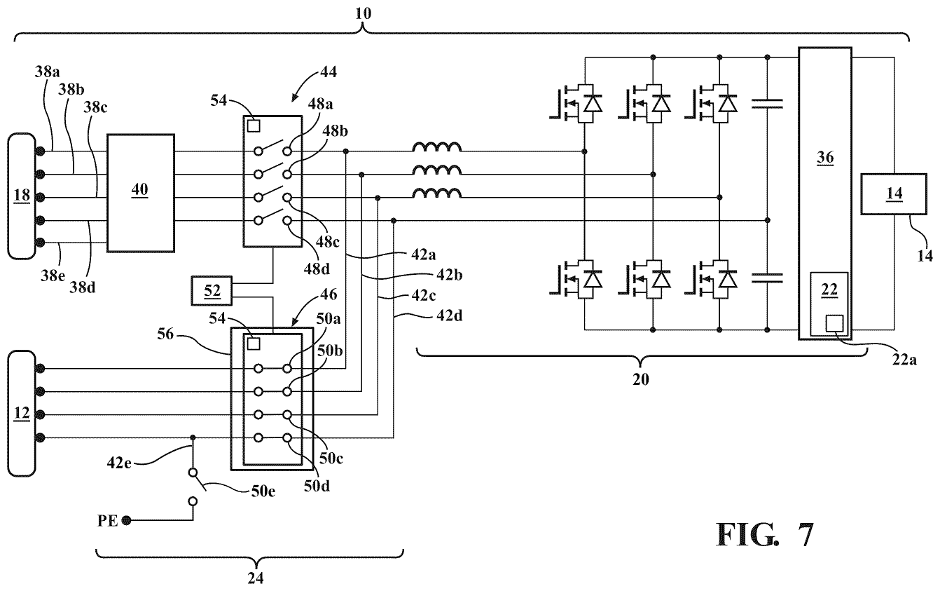

FIGS. 6 and 7 depict an instance where the battery 14 provides power to the outlet 12 for powering an electric device 28, that is the first power source 16 is not connected to the power inlet 18 and the vehicle 26 is off-grid. In such an instance, the splitter module 24 may be configured to provide voltage to the outlet 12 at a predetermined voltage and phase. With reference first to FIG. 6, the first processing unit 22 or the second processing unit 52 processes the information from the sensor 54 and configures the first switch unit 44 and the second switch unit 46 to provide a single phase of 110 volts to the outlet 12. For instance, the first input switch 48a, the second input switch 48b, the third input switch 48c, and the fourth input switch 48d are opened, thus electrical power from the battery 14 is transmitted to the second switch unit 46 wherein the first output switch 50a and the fourth output switch 50d are closed and the second output switch 50b and the third output switch 50c are open. In such an aspect, the power control system 10 need not employ an AC-AC converter 56 as the onboard charger module 20 may be configured to step up or step down the voltage. However, it should be appreciated that the power control system 10 may employ the AC-AC converter, as shown in FIG. 6.

With reference now to FIG. 7, the power control system 10 is configured to provide power from the battery 14 to the outlet 12 at 220 volts at three phases. In such an instance, the first processing unit 22 or the second processing unit 52 processes the information from the sensor 54 and configures the first switch unit 44 and the second switch unit 46 to provide three phases of 220 volts to the outlet 12. For instance, the first input switch 48a, the second input switch 48b, the third input switch 48c, and the fourth input switch 48d are opened, thus electrical power from the battery 14 is transmitted to the second switch unit 46 wherein the first output switch 50a, the second output switch 50b, the third output switch 50c, and the fourth output switch 50d are closed. In such an aspect, power from the battery 14 may need to be stepped up in which case the either the AC-AC converter 56 or the onboard charger module 20 may be configured to step up the voltage.

Accordingly, the disclosure provides for a power control system 10 configured to provide power to an outlet 12 that may be different than the power transmitted by the first power source 16 or the power needed to charge the battery 14. Accordingly, the power control system 10 is adaptable to handle charging stations with different power transmission characteristics as well as power various electric devices 28, to include another electric vehicle. For instance, if the electric device 28 is a laptop computer configured for U.S. outlets, the power control system 10 is configured to provide power to the outlet at 120 volts at a single phase, irrespective of the characteristics of the power transmitted from the first power source 16. On the other hand, if the electric device 28 is a laptop computer configured for European outlets, the power control system 10 is configured to provide power to the outlet at 220 volts or 230 volts in three phases. As discussed above, the power control system 10 may be adapted to include a plurality of outlets 12. In some aspects, each of the outlets 12 may be configured to provide different power, e.g. 110 volts at a single phase, 220 volts at three phases, 110 volts at a three phase, in which case the power control system 10 would include additional output lines and output switches.

A number of implementations have been described. Nevertheless, it will be understood that various modifications may be made without departing from the spirit and scope of the disclosure. Accordingly, other implementations are within the scope of the following claims. For instance, in some examples the power control system 10 is described as converting 220 volts in three phases to 220 volts at a single phase or transmitting 110 volts at a single phase from the first power source 16 to 110 volts at a single phase to the outlet 12. It should be appreciated that the exact voltage is provided as an example and the voltage and phase transmitted by the first power source 16 may be based on an industry or national standard that is different than is what described and thus the voltages and phases are not limiting to the scope of the appended claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A power control system for providing power to an outlet and a battery, the battery configured to power a motor, the power control system providing power to the outlet and the battery from a first power source, the first power source transmitting electric power in the form of an alternating current, the power control system comprising:
an onboard charger module including a first processing unit configured to process electric power from the first power source to charge the battery, the first processing unit including a non-volatile memory that stores written instructions for the execution of the onboard charger module; and
a splitter module interposed between the first power source and the onboard charger module, the splitter module operable to provide electric power in one of a plurality of phases.

2. The power control system as set forth in claim 1, wherein the plurality of phases includes a single phase and a three phase.

3. The power control system as set forth in claim 1, wherein the splitter module includes a first switch unit and a second switch unit.

4. The power control system as set forth in claim 3, further comprising a first input line, a second input line, a third input line, and a fourth input line, the fourth input line being a neutral line, the first input line, the second input line, the third input line, and the fourth input line connecting the first power source to the battery.

5. The power control system as set forth in claim 4, further comprising a first output line, a second output line, a third output line, and a fourth output line, the fourth output line being a neutral line.

6. The power control system as set forth in claim 5, wherein one end of the first output line, the second output line, the third output line, and the fourth output line is connected to a corresponding one of the first input line, the second input line, the third input line, and the fourth input line and the other end of the first output line, the second output line, the third output line, and the fourth output line is connected to the outlet.

7. The power control system as set forth in claim 6, wherein the first switch unit is configured to selectively open and close each one of the first input line, the second input line, the third input line, and the fourth input line.

8. The power control system as set forth in claim 7, wherein the second switch unit is configured to selectively open and close each one of the first output line, the second output line, the third output line, and the fourth output line.

9. The power control system as set forth in claim 8, further including alternating current-alternating current converter (AC-AC converter).

10. The power control system as set forth in claim 9, wherein the second switch unit is disposed within the AC-AC converter.

11. The power control system as set forth in claim 10, wherein the AC-AC converter is one of a buck converter, buck-boost converter, and single-ended-primary-inductor converter.

12. An electric vehicle including a battery for powering a drive force of the electric vehicle, an inlet for receiving electric power from a first power source, and an outlet for powering a load, the electric vehicle comprising:
a first input line, a second input line, a third input line, and a fourth input line, the fourth input line being a neutral line, the first input line, the second input line, the third input line, and the fourth input line connecting the inlet to the battery;
a first output line, a second output line, a third output line, and a fourth output line, the fourth output line being a neutral line, wherein one end of the first output line, the second output line, the third output line, and the fourth output line is connected to a corresponding one of the first input line, the second input line, the third input line, and the fourth input line and the other end of the first output line, the second output line, the third output line, and the fourth output line is connected to the outlet;
an onboard charger module including a first processing unit configured to process the electric power from the first power source to charge the battery, the first processing unit including a non-volatile memory that stores written instructions for the execution of the onboard charger module; and
a splitter module interposed between the first power source and the onboard charger module, the splitter module operable to transmit the electric power in one of a plurality of phases.

13. The electric vehicle as set forth in claim 12, wherein the splitter module includes a first switch unit and a second switch unit.

14. The electric vehicle as set forth in claim 13, wherein the first switch unit is configured to selectively open and close each one of the first input line, the second input line, the third input line, and the fourth input line.

15. The electric vehicle as set forth in claim 14, wherein the second switch unit is configured to selectively open and close each one of the first output line, the second output line, the third output line, and the fourth output line.

16. The electric vehicle as set forth in claim 15, wherein the splitter module includes a sensing unit configured to measure a value of at least one of a current and a voltage.

17. The electric vehicle as set forth in claim 16, wherein the splitter module includes a second processing unit, the second processing unit receiving the measured value of at least one of the current and the voltage to actuate the first switch unit and the second switch unit.

18. The electric vehicle as set forth in claim 17, wherein the first processing unit of the onboard charger module transmits a charging information of the battery to the second processing unit of an AC-AC converter, wherein the second processing unit processes the charging information to control the first switch unit and the second switch unit to transmit electric power in a selected one of the plurality of phases to the outlet and the battery.

19. The electric vehicle as set forth in claim 18, further including an alternating current-alternating current converter (AC-AC converter).

20. The electric vehicle as set forth in claim 19, wherein the second switch unit is disposed within the AC-AC converter.
